(19) United States
(12) Patent Application Publication
(10) Pub. No.: US 2004/0018466 A1
(43) Pub. Date: Jan. 29, 2004

(54) Adjustable dental impression trays

(76) Inventor: Jin-Keun Dong, Seoul (KR)

Correspondence Address: Supervisor Patent Prosecution Services, Piper Rudnick LLP, 1200 Nineteenth Street NW, Washington, DC, 20036-2412, US

(21) Appl. No.: 10/415,496

(22) PCT Filed: Oct. 29, 2001
(86) PCT No.: PCT/KR01/01826

(30) Foreign Application Priority Data
Oct. 31, 2000 (KR) 2000/30394U

(51) Int. Cl. A61C 9/00

(52) U.S. Cl. 433/43

(57) ABSTRACT

Dental impression trays for obtaining an impression of an arch by using the impression material according to this invention are characterized by comprising: a maxillary tray (10), which is adjustable according to the arch size by forming a U-shaped stray curved in the arch form for receving the impression material with resprectively extended hinge plates (12) being fixed to its center where the tray is divided into two and with fastening pants being engaged with said hinge plates (12), and a mandibular tray (20), which is adjustable according to the arch size by forming a U-shaped tray curved in teh arch form for receiving the impression material with respectively extended hinge plates (12) being fixed to its center where the tray is divided into two and with fastening parts being engaged with said hinge plates (12).

### TECHNICAL FIELD

This invention relates to the dental impression trays, particularly to adjustable dental impression trays that can provide an exact impression promptly by adjusting their width with ease according to the size and the configuration of the arch in a patient's oral cavity.

### BACKGROUND ART

In case any loss or damage takes place in teeth of a patient, dentistry requires a replicated model of his oral cavity for diagnosis and treatment thereof, and the production of the model requires a process of obtaining the impression thereof by using the impression material.

In the process of obtaining any impression, what is called the modeling process, dental trays to contain the impression materials are used, and such dental impression trays are generally classified into ready-made (stock) trays and customized trays. In order to obtain more exact impression, customized trays fitted on an individual are manufactured from the model made by using the ready-made trays. So, ready-made trays could be regarded as one of the most basic apparatus for manufacturing an exact restoration.

The arch has the shape of a horse hoof formed by person's teeth and alveolar bones, and its size and shape differs from person to person. So, one set of ready-made dental impression trays usually comprises 4 maxillary trays (small, medium, large and extra large) and 3 mandibular trays (small, medium and large).

However, these conventional ready-made trays are so complex that even an expert has some difficulty in selecting and classifying them, and furthermore, there are some cases that none of such ready-made trays fits an individual. It is, therefore, difficult to obtain an exact impression through such conventional ready-made trays.

### DISCLOSURE OF INVENTION

This invention is intended to provide a solution to said problem, more specifically, to provide adjustable dental impression trays so as to get an exact impression promptly by adjusting their width with ease according to the size and the configuration of the arch in a patient's oral cavity.

### BRIEF DESCRIPTION OF DRAWINGS

FIG. 1 is an exploded perspective view of the main parts of trays according to this invention.

### BEST MODE FOR CARRYING OUT THE INVENTION

Dental impression trays for obtaining an impression of an arch by using the impression material for the purpose of accomplishing said object of the invention are characterized by comprising a maxillary tray (10), which is adjustable according to the arch size by forming a U-shaped tray curved in the arch form for receiving the impression material with respectively extended hinge plates (12) being fixed to its center where the tray is divided into two, and with fastening parts being engaged with said hinge plates (12); and a mandibular tray (20), which is adjustable according to the arch size by forming a U-shaped tray curved in the arch form for receiving the impression material with respectively extended hinge plates (12) being fixed to its center where the tray is divided into two, and with fastening parts being engaged with said hinge plates (12).

Dental impression trays according to this invention is also characterized in that said maxillary tray (10) is equipped with a stop (11) of a uniform thickness which is respectively provided in both sides of the tray and an opening (10a) is formed at the opposite side to the stop in the one halved tray so that the other halved tray may access each other through the opening.

Further, dental impression trays according to this invention is also characterized in that said mandibular tray (20) is equipped with a holder (21) of a uniform thickness which is respectively provided in both sides of the tray and an opening (20a) is formed at the opposite side to the holder in the one halved tray so that the other halved tray may access each other through the opening.

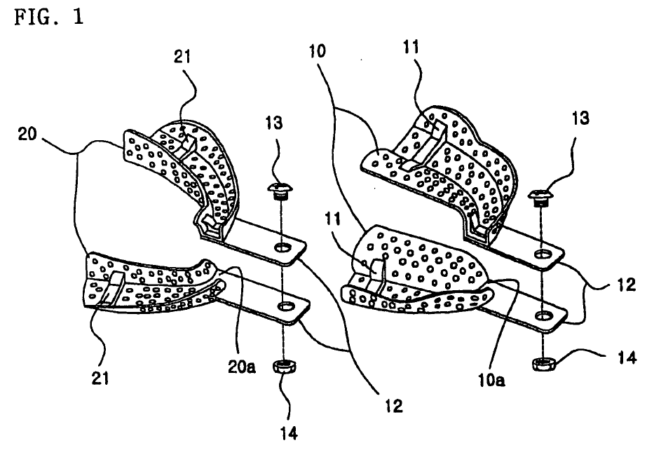

A preferable embodiment according to this invention is below described in detail with reference to the accompanied FIG. 1.

FIG. 1 is an exploded perspective view of the main parts of the trays according to this invention.

Dental impression trays for obtaining an impression of an arch by using the impression material according to this invention comprise a maxillary tray (10) and a mandibular tray (20).

The maxillary tray (10) is manufactured in the form of the U-shaped tray curved in the arch form for receiving the impression material. The mandibular tray (20) is also manufactured in the form of the U-shaped tray curved in the arch form for receiving the impression material. Since the maxillary tray (10) and the mandibular tray (20) are formed out of metal or a synthetic resin with small retaining holes being provided on the whole therein, they retain the impression material stably.

The maxillary tray (10) and the mandibular tray (20) are not of one solid horse hoof's shape, but of a horse hoof's shape that is divided into two. And respective hinge plate (12) is fixed to the center of each tray with being extended forward from its center. Each hinge plate has a hole through which the plate is engaged with fastening parts consisting of a bolt (13) and a nut (14). Each tray is, therefore, adjustable according to the arch size. Each hinge plate (12) joins to each halved tray so that its length may be provided to the extent that the plate protrudes forward so sufficiently that it is handy to hold the plate by hand with the maxillary tray (10) and the mandibular tray (20) being inserted into the oral cavity of a patient. The fastening parts act as a center of rotation around which the maxillary tray (10) and the mandibular tray (20) may move respectively.

In fastening parts, rivet and the like can also be used instead of the bolt (13) and the nut (14), whereby the impression can be obtained with the tray size being fixed. The fastening parts should enable the hinge plate (12) to move around them with ease by hand, and also should provide a constraining force appropriately so that the hinge plate (12) can stably be kept in a certain position where its rotation is stopped. It is, therefore, preferable to adopt a method for providing an elastic force by installing a spring washer and the like additionally therein.

Also, the maxillary tray (10) and the mandibular tray (20) according to this invention have respective stops (11)(21) provided in both sides thereof. The stops (11)(12) are means for preventing the maxillary tray (10) and the mandibular tray (20) from deforming in the process of obtaining the impression, and they should be prepared by using material of which the mechanical strength is relatively high. Then, they should be joined to an appropriate position in each tray.

FIG. 1 shows an example of the position of the stops (11)(21), wherein the stops are provided at one point of the anterior teeth section and at two points of the molar teeth section.

Also, in the maxillary tray (10) and the mandibular tray (20) of the invention, the openings (10a)(20a) are formed at the opposite sides to the stops in the one halved tray so that the other halved tray may access each other through the openings. In case that the trays are used for any patient having a big arch, respective halved tray of the maxillary tray (10) and the mandibular tray (20) does not meet each other so that the openings (10a)(20a) do not function. However, in case that the trays are used for any patient having a small arch, the one halved tray thereof slides into the other halved tray thereof through the said opening.

Said stops (11)(21) should joins to respective points of three sections of each tray excluding the section where the opening (10a)(20a) is formed, so that respective halved trays of the maxillary tray (10) and the mandibular tray (20) may be interlocked smoothly.

As shown in FIG. 1, the maxillary tray (10) is a U-shaped tray of which the width is wide so that it may be in contact with the palate, while the mandibular tray (20) is a narrow U-shaped tray with its central portion open so that it may be in contact with the lateral lingual border. However, this invention is not limited only to this configuration.

As described above, dental impression trays according to the present invention has an effect of obtaining an exact impression promptly by adjusting easily their width based on the size and the configuration of the arch in a patient's oral cavity.

The present invention is not limited to the examples described above, rather it is apparent to those skilled in the art that various modifications and equivalents can be made without escaping from the scope and the spirit of the invention. So, all such modifications and equivalents are intended to be included within the scope of the following claims.

What is claimed is:

1. Dental impression trays for obtaining an impression of an arch by using the impression material are characterized by comprising:
a maxillary tray (10), which is adjustable according to the arch size by forming a U-shaped tray curved in the arch form for receiving the impression material with respectively extended hinge plates (12) being fixed to its center where the tray is divided into two and with fastening parts being engaged with said hinge plates (12); and
a mandibular tray (20), which is adjustable according to the arch size by forming a U-shaped tray curved in the arch form for receiving the impression material with respectively extended hinge plates (12) being fixed to its center where the tray is divided into two and with fastening parts being engaged with said hinge plates (12).

2. Dental impression trays according to claim 1,
characterized in that said maxillary tray (10) is equipped with a stop (11) of a uniform thickness which is respectively provided in both sides of the tray and an opening (10a) is formed at the opposite side to the stop in the one halved tray so that the other halved tray may access each other through the opening.

3. Dental impression trays according to claim 1,
characterized in that said mandibular tray (20) is equipped with a holder (21) of a uniform thickness which is respectively provided in both sides of the tray and an opening (20a) is formed at the opposite side to the holder in the one halved tray so that the other halved tray may access each other through the opening.
